(19) United States
(12) Patent Application Publication
(10) Pub. No.: US 2015/0338781 A1
(43) Pub. Date: Nov. 26, 2015

(54) METHOD OF PRODUCING LOW-MIGRATION PRINTED MATERIALS

(71) Applicant: Océ Printing Systems GmbH & Co. KG, Poing (DE)

(72) Inventor: Astrid Bernsdorf, Munchen (DE)

(21) Appl. No.: 14/720,146

(22) Filed: May 22, 2015

(30) Foreign Application Priority Data
May 23, 2014 (DE) 10 2014 209 871.8

(51) Int. Cl. G03G 15/00

(52) U.S. Cl. CPC G03G 15/10

(57) ABSTRACT

The present disclosure relates to a method for printing on a recording medium, wherein the recording medium is pre-treated before the printing with at least one mineral oil-free, low-migration pre-treatment material, as well as a printing arrangement for printing on a recording medium, with at least one printing apparatus which is designed to print on the recording medium on at least one side of the recording medium, with a pre-treatment apparatus arranged in printing direction before the printing apparatus and designed to pre-treat the recording medium before the printing with at least one mineral oil-free, low-migration pre-treatment material.

### CROSS-REFERENCE TO RELATED APPLICATION

This application claims the benefit of and priority to German Patent Application No. 10 2014 209 871.8 filed May 23, 2014, the entire disclosure of which is incorporated by reference herein.

### TECHNICAL FIELD

The present disclosure relates to a method for printing on a recording medium, wherein the recording medium is pre-treated before the printing with at least one mineral oil-free, low-migration pre-treatment material, as well as a printing arrangement for printing on a recording medium, with at least one printing apparatus which is designed to print on the recording medium on at least one side of the recording medium, with a pre-treatment apparatus arranged in printing direction before the printing apparatus and designed to pre-treat the recording medium before the printing with at least one mineral oil-free, low-migration pre-treatment material.

### BACKGROUND

The passage of mineral oils from mineral oil-containing printing ink to food when printing food packaging or recycling cartons presently presents a problem that, among others, the printing industry, respectively packaging industry, is confronted.

Cartons for packaging are produced to a big extent from recycled waste paper for ecological reasons. Experiments show that recycled cartons can contain high contents of mineral oil. Origin of the mineral oils is printing inks that are generally used in printing newspapers. If food like rice for example is packed in such cartons mineral oils can migrate from the carton to the food in bigger amounts. A further source can be printing the packaging of food with mineral oil-containing ink.

A transfer of mineral oils is prevented, respectively decreased, by using low-migration, mineral oil-free inks in printing food packaging as well as by using suitable barrier layers in packaging structure (inner bags, laminates, etc.).

However, this is in part technically complex or requires specially produced dyes which can be more expensive or can give rise to further environmental or production problems.

### SUMMARY

Based on this background it is an object of the present disclosure to provide a correspondingly improved method of producing low-migration printing goods as well as a corresponding printing arrangement, particularly for printing packages and especially in the area of packaging for food.

This object is achieved by a method and/or by a printing arrangement with the features disclosed herein.

Advantageous configurations and developments emerge from the description with reference to the figures of the drawings.

The configurations and developments herein can be, as far as it makes sense, arbitrarily combined with each other. Further possible configurations, developments and implementations of the disclosure herein comprise also no explicitly mentioned combinations of features of the disclosure herein mentioned before or regarding the embodiments described herein. In particular, the skilled person will also add single aspects as improvements or supplements to the respective basic form of the present disclosure.

### BRIEF DESCRIPTION OF THE DRAWINGS

The present disclosure will be described below with reference to the embodiments indicated in the schematic figures of the drawings, in which:

FIG. 1 is a view of a digital printer in the case of an exemplary configuration of the printing arrangement of the present disclosure;

FIG. 2 shows a schematic construction of a printing unit of the digital printer according to FIG. 1.

The elements in the drawings are not necessarily shown true to scale in relation to one another.

In the figures of the drawings, elements, features and components which are like, functionally like or have a like effect are each provided with the same reference numerals, unless indicated otherwise.

### DETAILED DESCRIPTION

First, in the context of the present patent application, the following terms are to be understood as follows:

A mineral oil is to be understood as an oil produced by distillation of crude oil und, where applicable, also other mineral raw material, which generally can contain paraffinic (saturated chain-like hydrocarbons, naphthenic (saturated cyclic hydrocarbons) and aromatic (cyclic hydrocarbons with a system of aromatic double bonds) components as well as, where applicable, olefins and/or, where applicable, sulfur-containing and/or nitrogen-containing organic compounds.

Migration is to be understood in industry generally as a relocation of a substance in different industrial products, as e.g. mineral oil in paper and/or cartons, respectively further, pulp containing materials.

Low-migration materials are—in the scope of the disclosure herein—materials which only have a low migration potential, i.e. a material transfer of less than 10 ppb, i.e. less than 10 μg material per kg filler or less than 1.6 μg/dm² recording medium, and preferably materials which have no migration potential. Such materials are for example materials with a high viscosity of higher than 5 mm²/s (cSt) at 100° C., preferably higher than 11 mm²/s (cSt) at 100° C., measured with an Ubbelohde viscometer according to DIN 51562, and/or a high molecular weight of more than 500 Da, preferably more than 1000 Da, and/or with branched molecular structures, e.g. manifold branched molecular structures (2 or more branches in the molecule).

Fatty acids are—within the scope of the disclosure herein—aliphatic monocarbonic acids which can be saturated or unsaturated, branched or not branched, and can have further functional groups like epoxy groups or hydroxyl groups, but will have no further functional groups according to certain embodiments. Examples for fatty acids are formic acid, acetic acid, propionic acid, butyric acid, valeric acid, caproic acid, caprylic acid, capric acid, lauric acid, myristic acid, palmitic acid, stearic acid, arachidic acid, behenic acid, lignoceric acid, cerotic acid, melissic acid, myristoleic acid, palmitoleic acid, oleic acid, elaidic acid, gadoleic acid, 11-eicosenoic acid, cetoleic acid, erucic acid, nervonic acid, linoleic acid, alpha-linolenic acid, gamma-linolenic acid, calendic acid, punicic acid, alpha-elaeostearic acid, beta-elaeosteric acid, arachidonic acid, vernolic acid, ricinoleic acid, preferably fatty acids with 6 to 40 carbon atoms.

Branched fatty acid esters are—within the scope of the present disclosure—esters of fatty acids, wherein these can have at least one branch in the molecular structure, wherein the branch can be present in the fatty acid residue as well as in the further ester component, for example a polyol. Examples for branched fatty acid esters are esters of fatty acids on the basis of polyethylene glycol, glycerol, pentaerythritol, sorbitan, xylitol or further polyols, preferably polyethylene glycol, sorbitan or pentaerythritol.

Pulp-containing and pulp-free recording media can be used as recording medium according to the disclosure herein, wherein these pulp-free recording media preferably have at least a pore structure.

Pulp is—within the scope of the disclosure herein—the fibrous mass which under most circumstances mostly consists of cellulose and which is generated when decomposing wood or other plant fibers. Also recording media that are purely based on cellulose are to be understood as pulp-containing recording media according to the disclosure herein.

For example, recording media based on pulp-containing paper, e.g. also recycled paper, cardboard and/or carton, respectively cardboard packaging, can therefore be named as pulp-containing recording media.

In addition, also pulp-free papers or other pulp-free materials are known that can be used as recording media according to the disclosure herein, wherein such pulp-free recording media preferably have a pore structure.

According to preferred embodiments pulp-containing recording media are used, which can be treated by the pre-treatment materials in the inventive method particularly well in such a way that migration of mineral oils can be largely decreased or even prevented.

A liquid developer comprises toner particles and an oil carrier according to the disclosure herein, wherein the toner particles and the oil carrier are not further restricted and comprise those that are usually present in liquid developers. According to certain embodiments the oil carrier comprises mineral oil. Resin particles that contain dyes can serve as toner particles, for example. A liquid developer is distinctly different from ink which is used in inkjet methods, for example, wherein the ink can be present as a suspension of pigments or in the form of solved dye, but does not comprise toner. According to certain embodiment the liquid developer is liquid toner. The method of the disclosure herein is preferably not an inkjet method, and the arrangement of the disclosure herein is preferably also no inkjet printing arrangement, but an arrangement in which a liquid developer that comprises toner particles and an oil carrier can be coated on a recording medium.

A uniform coating of the pre-treatment material on the recording medium is achieved if the coating takes place over the whole area of the recording medium, e.g. on one side or 2 sides, in such a way that an amount of pre-treatment material is coated on a defined area of the recording medium, e.g. 1 cm², which does not deviated for not more than 50%, preferably not more than 20% and particularly preferably not more than 10% from the total amount of coated pre-treatment material in relation to the whole area coated therewith.

According to an aspect the present disclosure relates to a method for printing on a recording medium, wherein the recording medium is pre-treated before the printing with at least one mineral oil-free, low-migration pre-treatment material selected from branched fatty acid esters with a molecular weight of at least 500 daltons, preferably more than 1000 daltons, and/or a viscosity of higher than 5 mm²/s (cSt) at 100° C., preferably higher than 11 mm²/s (cSt) at 100° C., measured with an Ubbelohde viscometer according to DIN 51562, preferably in liquid form. According to certain embodiments, the pre-treatment can thus take place with at least one mineral oil-free, low-migration pre-treatment material selected from branched fatty acid esters with a molecular weight of at least 500 daltons, preferably more than 1000 daltons, and/or solutions of branched fatty acid esters with a molecular weight of at least 500 daltons, preferably more than 1000 daltons, preferably in liquid form. According to certain embodiments, the pre-treatment can also take place with at least one mineral oil-free, low-migration pre-treatment material selected from branched fatty acid esters with a viscosity of higher than 5 mm²/s (cSt) at 100° C., preferably higher than 11 mm²/s (cSt) at 100° C., measured with an Ubbelohde viscometer according to DIN 51562, and/or solutions of branched fatty acid esters with a viscosity of higher than 5 mm²/s (cSt) at 100° C., preferably higher than 11 mm²/s (cSt) at 100° C., measured with an Ubbelohde viscometer according to DIN 51562, preferably in liquid form.

According to certain embodiments, the mineral oil-free, low-migration pre-treatment material consists of one or more branched fatty acid esters with a molecular weight of at least 500 daltons, preferably more than 1000 daltons, and/or a solution of one or more branched fatty acid esters with a molecular weight of at least 500 daltons, preferably more than 1000 daltons, preferably in liquid form, and/or of one or more branched fatty acid esters with a viscosity of higher than 5 mm²/s (cSt) at 100° C., preferably higher than 11 mm²/s (cSt) at 100° C., measured with an Ubbelohde viscometer according to DIN 51562, and/or solutions of branched fatty acid esters with a viscosity of higher than 5 mm²/s (cSt) at 100° C., preferably higher than 11 mm²/s (cSt) at 100° C., measured with an Ubbelohde viscometer according to DIN 51562, preferably in liquid form. According to certain embodiments, the mineral oil-free, low-migration pre-treatment material thus contains one or more branched fatty acid esters with a molecular weight of at least 500 daltons, preferably more than 1000 daltons, and/or one or more branched fatty acid esters with a viscosity of higher than 5 mm²/s (cSt) at 100° C., preferably higher than 11 mm²/s (cSt) at 100° C., measured with an Ubbelohde viscometer according to DIN 51562, and optionally one or more solvents. According to certain embodiments, no further material/compound is included in the mineral oil-free, low-migration pre-treatment material beside the one or more branched fatty acid esters and optionally one or more solvents. According to certain embodiments, no solvents or other materials are included in the pre-treatment material that are not low-migration materials, e.g. silicon oils, vegetable oils, glycols, alcohols not fulfilling the criteria as defined above.

The treatment is herein not limited to a pre-treatment material in liquid form and can, for example, also take place with a pre-treatment material in the form of a gas, of an aerosol, a sol, or similar, wherein, however, according to certain embodiments, an application in form of a liquid or an aerosol, preferably a liquid, can be realized technically in an easier way and/or leads to better results during pre-treatment. The application of the pre-treatment material is carried out therein according to certain embodiments temporally as well as locally in printing direction before a further treatment of the recording medium, e.g. a printing or a further pre-treatment and/or an intermediate and/or post-treatment like an intermediate fixation or a fixation of the liquid developer. After the pre-treatment the recording medium is printed with a liquid developer that comprises toner particles and an oil carrier, e.g. comprising mineral oil, according to certain embodiments.

According to certain embodiments, the liquid developer comprises toner particles and a mineral oil-containing oil carrier. Thus, according to certain embodiments, the present method for printing on a recording medium includes at least one step of printing on the recording medium with a liquid developer comprises toner particles and a mineral oil-containing oil carrier. This step is then carried out after the pre-treatment step, wherein the term “after” refers to the printing carried out in the printing arrangement in a printing apparatus in printing direction after the pre-treatment in a pre-treatment apparatus.

According to certain embodiments, the present method for printing on a recording medium is carried out on recording media which are used afterwards for food packaging, wherein environmental and food safety aspects have to be taken into consideration. The present method is thus carried out for the purpose of avoiding that the mineral oil-containing oil carrier permeates into the recording medium, respectively penetrates the recording medium, e.g. avoiding that the mineral oil-containing carrier passes over to the packed food via migration through the recording medium.

According to certain embodiments the pre-treatments is carried out in-line, i.e. between entry of the recording medium and the first printing apparatus in the printing arrangement so that an effective coating of the pre-treatment materials can be guaranteed and further no perturbing outside influences, like dust, but also draft which can lead to an uneven/non-uniform coating, have an effect on the coating. However, also an off-line pre-treatment can be carried out, although it is not preferred.

The pre-treatment agent is, according to certain embodiments, selected from branched fatty acid esters with a molecular weight of at least 500 daltons, like polyethylene glycol ester, polyoxyethylene sorbitan monolaurate, pentaerythritol tetraoctanoate, and/or solutions of branched fatty acid esters, wherein also here the branched fatty acid esters have a molecular weight of at least 500 daltons. The mentioned pre-treatment materials are advantageous for environmental as well as process-technical reasons. In addition, they are suitable for printing packages and particularly packages for food. The solutions of the branched fatty acid esters can be prepared in a suitable solvent, like e.g. an alcohol, glycol, water, and/or mixtures thereof or with further solvents, wherein form an environmental view as well as for procedural reasons preferably water can be used. Also, solvents, respectively solvent mixtures, are preferred which are not problematic with regard to food technology.

The type of coating of the pre-treatment materials is not particularly limited according to the disclosure herein and can be carried out in a suitable way, e.g. using nozzles, rollers, doctor blades, or similar by spraying, coating, or rolling, etc. The mineral oil-free, low migration pre-treatment material can thereby be penetrated into the recording medium. According to certain embodiments the pre-treatment material can be applied on the recording medium uniformly, wherein a uniform coating is carried out as defined above. According to certain embodiments the coating of the pre-treatment material ensures that a low-migration layer is obtained over the whole area of the recording medium, at least, however, in the area of the recording medium to be printed on, in which migration takes place with less than 10 ppb, i.e. less than 10 μg material per kg filler or less than 1.6 μg/dm² recording medium, respectively that no migration takes place there or throughout the whole area of the recording medium. This can guarantee a uniform quality of the recording medium.

The time for applying the pre-treatment material is not particularly limited according to the disclosure herein as long as it can be ensured that enough pre-treatment material is applied on the recording medium in order to suitably decrease migration, respectively prevent migration according to certain embodiments. According to certain embodiments the pre-treatment with the pre-treatment material is carried out for a time of 1 ms till 10 s, preferably for a time of less than 1 s. In such a period of time a good pre-treatment can be obtained, particularly when carrying out the pre-treatment in-line. For off-line pre-treatment the time is not particularly restricted according to certain embodiments.

Further, the temperature at which the pre-treatment material is coated is not particularly restricted according to the disclosure herein and can be suitably determined according to the pre-treatment material and its desired type of coating, e.g. in liquid form. According to certain embodiments the pre-treatment with the pre-treatment material can be carried out at a temperature in the range of 10° C. to 120° C., preferably at a temperature in the range of 20° C. to 40° C., particularly when carrying out the pre-treatment in-line. This can, on the one side, prevent damaging the recording medium and further enables a simple procedure as well as avoid interference with or impairment of the printing procedure. For off-line pre-treatment, also the temperature is not particularly restricted according to certain embodiments.

After the pre-treatment the recording medium can be printed on one or two sides and, if applicable, be fixed thereafter, wherein in two-sided printing also an intermediate fixation can take place. Also cooling or heating steps and/or steps for re-wetting of the recording medium can follow after the respective printing, as well as further steps, if applicable. The printing can be carried out with one or more colors. The different steps herein can be suitably carried out, for example according to established ways in existing printing arrangements.

According to certain embodiments, no primer is applied to the paper, e.g. a wax-containing primer. Also, the pre-treatment material does not have the function of a primer according to certain embodiments, but serves to impregnate the recording medium with a material with a material that is unproblematic from the viewpoint of food safety. Such impregnation can prevent mineral oil from entering into, respectively penetrating the recording medium, particularly substrate pores in the recording medium.

According to certain embodiment, solvent residues of the printing ink, e.g. mineral oils, remaining after the printing, are removed, preferably by a drying process. According to certain embodiments, residues of mineral oil-containing oil carrier remaining after the printing on the recording medium are removed. The drying process is thereby not particularly limited and can be suitably determined based on the solvent, for example with regard to the temperature and/or the drying time. In this way it can be prevented that materials are remaining on mineral oil on the finished recording medium, which is particularly advantageous in view of a recycling of the recording medium and for the application in printing food packages.

According to certain embodiments the recording medium comprises paper, cardboard and/or carton, e.g. paper and/or carton. According to certain embodiments, the recording medium is paper, cardboard and/or carton, e.g. paper and/or carton. In this way a good decrease, respectively prevention, of migration can be obtained.

According to a further aspect the present disclosure relates to a printing arrangement for printing on a recording medium, preferably a pulp-containing recording medium, with liquid developer comprising toner particles and an oil carrier, wherein the printing arrangement comprises at least one printing apparatus for liquid developer comprising toner particles and an oil carrier, which is designed to print on the recording medium on at least one side of the recording medium, and a pre-treatment apparatus arranged in printing direction before the printing apparatus and designed to pre-treat the recording medium before the printing with at least one mineral oil-free, low-migration pre-treatment material.

The type of printing arrangement is not particularly limited, and usual printing arrangements, like digital printers, offset printers, etc., can be used in which a respective pre-treatment with a pre-treatment apparatus according to the disclosure herein is carried out. In a printing arrangement according to the disclosure herein also more than one printing apparatus can be provided, for example for two-sided printing, wherein it is to be ensured, however, that at least one printing apparatus can apply liquid developer comprising toner particles and an oil carrier, and preferably all printing apparatuses are designed to apply a liquid developer comprising toner particles and an oil carrier. In addition it can be printed with one or more colors. Furthermore, a printing arrangement according to the disclosure herein can comprise one or more fixing apparatuses and, if applicable, intermediate fixing apparatuses, turning devices, as well as cooling and/or heating apparatuses for setting a desired printing temperature. Also a device for re-moistening the recording medium can be present or further devices for pre- and/or post-treatment of the unprinted, respectively printed, recording medium. In addition, corresponding rollers for printing, treating and/or guiding of the recording medium, apparatuses for transferring a printing template to the recording medium, reservoirs for inks, etc. can be present in the printing arrangement of the disclosure herein. Moreover, apparatuses usually contained in existing printing arrangements can be contained in a printing arrangement of the disclosure herein, and these as well as the apparatuses mentioned above can be arranged in a suitable manner depending on printing operation, desired product, respectively used recording medium.

According to some embodiments the pre-treatment apparatus comprises an applicator designed to apply the pre-treatment material uniformly on the recording medium. This can for example be a roll/reel, a blade, an arrangement of nozzles, etc. The application can also take place under pressure. In addition, the applicator can be heated in order to warm up a pre-treatment material and thus ensure a better coating.

Moreover, a printing arrangement of the disclosure herein can comprise a heating device according to certain embodiments which is arranged in printing direction after the printing apparatus and designed to remove solvent residues of the printing ink remaining after the printing on the recording medium, for example mineral oils. This way it can be safely ensured that no mineral oils remain in the printed recording medium even if mineral oil-containing printing inks are used. The possible expensive and/or complex application of mineral oil-free printing inks can be avoided.

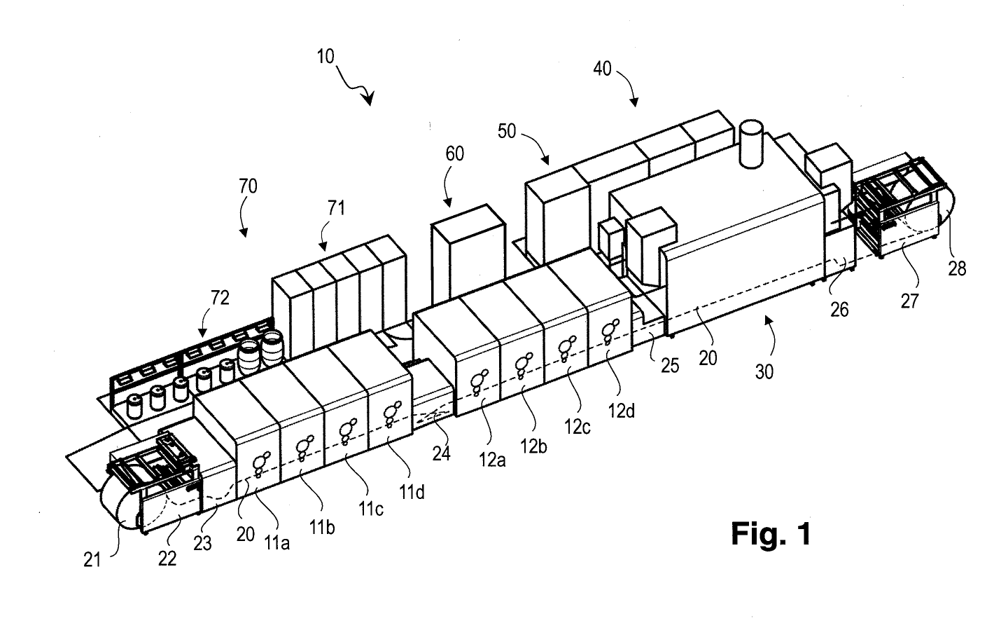

An exemplary embodiment of a printing arrangement according to the disclosure herein for two-sided printing is shown in FIG. 1 by way of a digital printer. Of course also a printing arrangement for one-sided printing can be realized according to the disclosure herein, wherein then components of the printing arrangement not required can be missing.

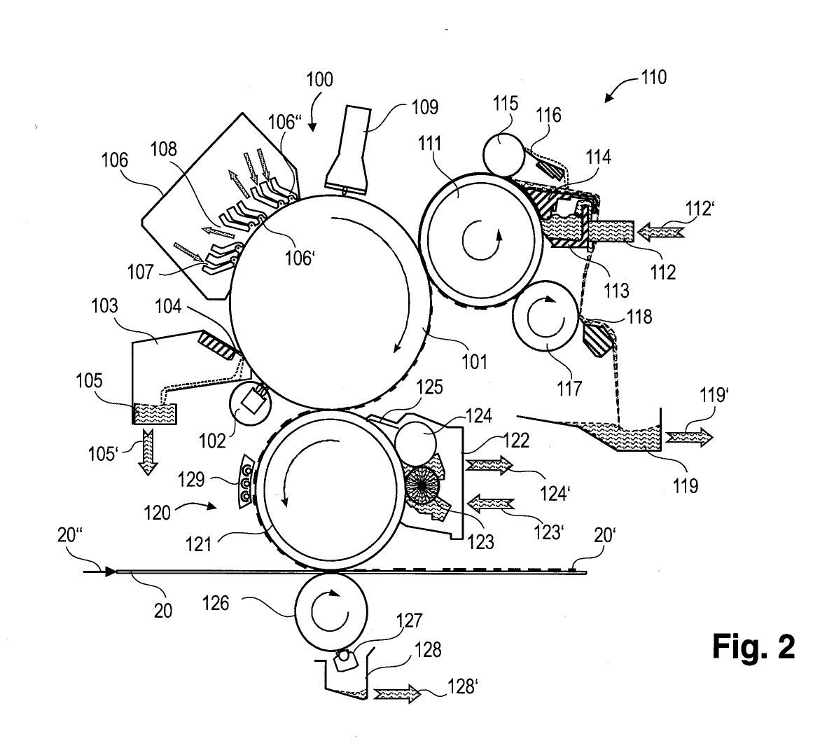

According to FIG. 1, a digital printer 10 for printing on a recording medium 20 comprises one or more printing units 11a-11d and 12a-12d which print a toner image (print image 20′; see FIG. 2) on the recording medium 20. As recording medium 20, a recording medium 20 in web form can, as shown, be unwound from a reel 21 by an unwinder 22 and fed to the first printing unit 11a. The print image 20′ is fixed on the recording medium 20 in a fixing apparatus 30. The recording medium 20 can then be wound onto a reel 28 by a rewinder 27. Such a configuration is also known as a reel-to-reel printer.

In the preferred configuration shown in FIG. 1, the recording medium 20 in web form is printed on in full color by four printing units 11a to 11d on the front and by four printing units 12a to 12d on the back (what is known as a 4/4 configuration). For this purpose, the recording medium 20 is unwound from the reel 21 by the unwinder 22 and fed to the first printing unit 11a via the pre-treatment apparatus/conditioning unit 23. In the pre-treatment apparatus 23 the recording medium 20 is pre-treated with a suitable pre-treatment material.

The recording medium 20 is then fed in turn to the first printing units 11a to 11d, in which only the front is printed on. Each printing unit 11a-11d usually prints on the recording medium 20 with a liquid developer in a different color or else with a different toner material in the liquid developer, for example MICR toner, which can be read electromagnetically.

After the printing on the front, the recording medium 20 is turned in a turning device 24 and fed to the remaining printing units 12a-12d for printing on the back. Optionally a further conditioning unit (not shown) can be arranged in the area of the turning device 24, by which the recording medium can be prepared for printing on the back side, e.g. by a starting fixing/intermediate fixing (partly fixing) or other conditioning of the previously printed front print image (respectively the whole front side or also back side). This prevents the front print image from being damaged mechanically during further transport through the subsequent printing units.

In order to achieve full-color printing, at least four colors (and thus at least four printing units 11, 12) are required, and specifically for example the basic colors YMCK (yellow, magenta, cyan and key). Further printing units 11, 12 using special colors (for example, client-specific colors or additional basic colors, in order to extend the printable color space) can also be used.

A register unit 25 is arranged downstream of the printing unit 12d and evaluates register marks which are printed on the recording medium 20 independently of the print image 20′ (in particular outside the print image 20′). The transverse and longitudinal register (the basic color dots which form a color dot should be arranged on top of one another or spatially very close to one another; this is also known as color register or four-color register) and the register (front and back must coincide precisely in space) can thus be adjusted, in order to achieve a qualitatively good print image 20′.

The fixing apparatus 30 is arranged downstream of the register unit 25 and fixes the print image 20′ onto the recording medium 20. In the case of electrophoretic digital printers, a thermal dryer, for example, which largely evaporates the carrier liquid, comprising e.g. mineral oil, is preferably used as a fixing apparatus 30 so that only the toner particles remain on the recording medium 20. This happens under the effect of heat. In this connection, the toner particles may also be melted onto the recording medium 20 if they comprise a material which is meltable under the effect of heat, for example resin.

A draw unit 26 is arranged downstream of the fixing apparatus 30 and draws the recording medium 20 through all the printing units 11a-12d and the fixing apparatus 30 without a further drive being arranged in this region, as a friction drive for the recording medium 20 would involve the risk of blurring the as yet unfixed print image 20′.

The draw unit 26 feeds the recording medium 20 to the rewinder 27, which rolls up the printed recording medium 20.

Arranged centrally next to the printing units 11, 12 and the fixing apparatus 30 are all the supply apparatuses for the digital printer 10, such as air conditioning modules 40, power supply 50, controller 60, liquid management modules 70, such as liquid control unit 71 and reservoirs 72 for the various liquids. In particular, pure carrier liquid comprising oil, highly concentrated liquid developer (high toner particle content in relation to the carrier liquid) and serum (liquid developer plus charge control agents) are required for supplying the digital printer 10. Waste containers for liquids to be disposed of or containers for cleaning liquid are also provided.

The digital printer 10 with its identically constructed printing units 11, 12 is constructed in a modular manner. The printing units 11, 12 do not differ mechanically but merely in terms of the liquid developer contained therein (toner color or toner type).

The basic construction of a printing unit 11, 12 is shown in FIG. 2. Such a printing unit is based on the electro-photographic principle by which a photoelectric image carrier is inked with charged toner particles by a liquid developer and the resulting image is transferred to the recording medium 20.

The printing unit 11, 12 basically comprises an electrophotography station 100, a developer station 110 and a transfer station 120.

At the core of the electrophotography station 100 is a photoelectric image carrier which comprises a photoelectric layer (known as a photoconductor) at its surface. In this case, the photoconductor is designed as a roller (photoconductor roller 101) and has a hard surface. The photoconductor roller 101 rotates past the various elements to produce a print image 20′ (rotation in the direction of the arrow).

The photoconductor is firstly cleaned of all impurities. For this purpose, an erasing light 102 is provided which erases the charges remaining on the surface of the photoconductor. The erasing light 102 is adjustable (locally variable) in order to achieve a homogeneous light distribution. The surface can thus be pre-treated uniformly.

After the erasing light 102, a cleaning apparatus 103 cleans the photoconductor mechanically in order to remove toner particles which may still be present on the surface of the photoconductor, possibly dirt particles and remaining carrier liquid. The carrier liquid which is cleaned off is fed to a collecting container 105. The collected carrier liquid and toner particles are processed (optionally filtered) and, depending on color, fed to a corresponding liquid ink supply, that is to say one of the reservoirs 72 (cf. arrow 105′).

The cleaning apparatus 103 preferably comprises a blade 104 which rests at an acute angle (approximately 10° to 80° to the delivery surface) against the outer face of the photoconductor roller 101 in order to clean the surface mechanically. The blade 104 can move back and forth at right angles to the direction of rotation of the photoconductor roller 101 in order to clean the outer face over the entire axial length with as little wear as possible.

The photoconductor is then charged at a predetermined electrostatic potential by a charging device 106. A plurality of corotrons (in particular glass-clad corotrons) is preferably provided for this purpose. The corotrons consist of at least a wire 106′ to which a high voltage is applied. The voltage ionises the air around the wire 106′. A screen 106″ is provided as a counter electrode. Fresh air which is supplied through special air ducts (air supply duct 107 for aeration and exhaust air duct 108 for venting) between the screens (see also air flow arrows in FIG. 2) also flows around the corotrons. The supplied air is then ionised uniformly at the wire 106′. As a result, homogeneous, uniform charging of the adjacent surface of the photoconductor is achieved. The uniform charging can be improved further by using dry and heated air. Air is removed via the exhaust air ducts 108. Any resulting ozone can also be drawn off via the exhaust air ducts 108.

The corotrons are cascadable, that is to say there are two or more wires 106′ per screen 106″ at the same screen voltage. The current which flows across the screen 106″ is variable and the charging of the photoconductor is thus controllable. Current can flow through the corotrons at different strengths in order to achieve uniform and sufficiently high charging of the photoconductor.

A character generator 109 is arranged downstream of the charging device 106 and discharges the photoconductor pixel by pixel via optical radiation according to the desired print image 20′. This results in a latent image which is subsequently inked with toner particles (the inked image corresponds to the print image 20′). Preferably, an LED character generator 109 is used in which an LED row comprising many individual LEDs is arranged in a stationary manner over the entire axial length of the photoconductor roller 101. The number of LEDs and the size of the optical imaging points on the photoconductor determine inter alia the resolution of the print image 20′ (typical resolution is 600×600 dpi). The LEDs can be controlled individually in time and in terms of their radiant power. Thus, multilevel methods can be used to produce dots (consisting of a plurality of picture elements or pixels) or picture elements can be delayed in order to carry out corrections electro-optically, for example in the case of incorrect color register or register.

The character generator 109 comprises a drive logic which must be cooled owing to the large number of LEDs and the radiant power thereof. The character generator 109 is preferably liquid-cooled. The LEDs can be driven in groups (a plurality of LEDs combined to form a group) or separately from one another.

The latent image produced by the character generator 109 is inked with toner particles by the developer station 110. For this purpose, the developer station 110 comprises a rotating developer roller 111 which introduces a layer of liquid developer onto the photoconductor (the mode of operation of the developer station 110 will be described in detail below). Since the surface of the photoconductor roller 101 is relatively hard, the surface of the developer roller 111 is relatively soft and the two are pressed against one another, a thin, tall nip (a gap between the rollers) is produced, in which the charged toner particles migrate electrophoretically from the developer roller 111 to the photoconductor in the image areas owing to an electric field. In the non-image areas, no toner passes onto the photoconductor. The nip filled with liquid developer has a height (thickness of the gap) which is dependent on the mutual pressure of the two rollers 101, 111 and the viscosity of the liquid developer. The thickness of the nip is typically in the range from greater than approximately 2 μm to approximately 20 μm (the values can also vary depending on the viscosity of the liquid developer). The length of the nip is approximately a few millimetres.

The inked image rotates with the photoconductor roller 111 to a first transfer point in which the inked image is transferred substantially completely onto a transfer roller 121. At the first transfer point (nip between photoconductor roller 101 and transfer roller 121), the transfer roller 121 moves in the same direction as and preferably at an identical speed to the photoconductor roller 101. After the transfer of the print image 20′ onto the transfer roller 121, the print image 20′ (toner particles) can optionally be recharged or charged by a charging unit 129, for example a corotron, in order for the toner particles to be transferred better onto the recording medium 20 afterwards.

The recording medium 20 passes in the transport direction 20″ between the transfer roller 121 and an impression roller 126. The contact region (nip) represents a second transfer point where the toner image is transferred onto the recording medium 20. In the second transfer region, the transfer roller 121 moves in the same direction as the recording medium 20. The impression roller 126 also rotates in this direction in the region of the nip. The speeds of the transfer roller 121, the impression roller 126 and the recording medium 20 are coordinated and preferably identical at the transfer point, in order not to smudge the print image 20′. At the second transfer point, the print image 20′ is transferred onto the recording medium 20 electrophoretically owing to an electric field between the transfer roller 121 and the impression roller 126. Moreover, the impression roller 126 presses against the relatively soft transfer roller 121 with a large mechanical force, whereby the toner particles also stick to the recording medium 20 owing to adhesion.

Since the surface of the transfer roller 121 is relatively soft and the surface of the impression roller 126 is relatively hard, upon rolling a nip is produced in which the toner transfer takes place. Unevennesses of the recording medium 20 can thus be compensated, such that the recording medium 20 can be printed on without gaps. Such a nip is also well suited for printing on relatively thick or relatively uneven recording media 20, as is the case for example in packaging printing.

Although the print image 20′ should pass completely onto the recording medium 20, a few toner particles may undesirably remain on the transfer roller 121. Some of the transfer liquid always remains on the transfer roller 121 owing to wetting. The toner particles which may remain should be removed virtually completely by a cleaning unit 122 downstream of the second transfer point. The carrier liquid remaining on the transfer roller 121 can also be removed from the transfer roller 121 completely or to a predetermined layer thickness in order that, downstream of the cleaning unit 122 and upstream of the first transfer point from the photoconductor roller 101 onto the transfer roller 121, the same conditions prevail owing to a clean surface or a defined layer thickness of liquid developer on the surface of the transfer roller 121.

This cleaning unit 122 is preferably designed as a wet chamber comprising a cleaning brush 123 and a cleaning roller 124. In the region of the brush 123, cleaning liquid (for example, carrier liquid or a separate cleaning liquid can be used) is supplied via a cleaning liquid inlet 123′. The cleaning brush 123 rotates in the cleaning liquid and “brushes” the surface of the transfer roller 121. The toner adhering to the surface is loosened as a result.

The cleaning roller 124 is at an electrical potential which is opposed to the charge of the toner particles. As a result, the electrically charged toner is removed from the transfer roller 121 by the cleaning roller 124. Since the cleaning roller 124 touches the transfer roller 121, it also removes carrier liquid remaining on the transfer roller 121 together with the supplied cleaning liquid. A conditioning element 125 is arranged at the outlet of the wet chamber. As shown, a retaining plate which is arranged at an obtuse angle (for example between 100° and 170° between plate and delivery surface) to the transfer roller 121 can be used as a conditioning element 125, whereby residues of liquid on the surface of the roller in the wet chamber are held back virtually completely and fed to the cleaning roller 124 for removal via a cleaning liquid drain 124′ to a cleaning liquid reservoir (not shown, among the reservoirs 72).

Instead of the retaining plate, a metering unit (not shown), which for example comprises one or more metering rollers, can also be arranged there. The metering rollers are at a predetermined distance from the transfer roller 121 and remove a quantity of carrier liquid such that a predetermined layer thickness is set downstream of the metering rollers owing to the squeezing. The surface of the transfer roller 121 is then not completely cleaned; carrier liquid remains over the entire surface to a predetermined layer thickness. Removed carrier liquid is recycled to the cleaning liquid reservoir via the cleaning roller 124.

The cleaning roller 124 itself is kept clean mechanically by a blade (not shown). Cleaned-off liquid, including toner particles, is collected for all colors by a central collecting container, cleaned and fed to the central cleaning liquid reservoir for recycling.

The impression roller 126 is also cleaned by a cleaning unit 127. As a cleaning unit 127, a blade, a brush and/or a roller can remove impurities (paper dust, toner particle residue, liquid developer, etc.) from the impression roller 126. The cleaned liquid is collected in a collecting container 128 and supplied to the printing process again via a liquid drain 128′, optionally in a cleaned state.

In the printing units 11 which print on the front of the recording medium 20, the impression roller 126 presses against the unprinted side (and thus the side which is still dry) of the recording medium 20.

Nevertheless, there may be dust/paper particles or other dirt particles on the dry side which are then removed by the impression roller 126. For this purpose, the impression roller 126 should be wider than the recording medium 20. As a result, impurities outside the print region can also be cleaned off effectively.

In the printing units 12 which print on the back of the recording medium 20, the impression roller 126 presses directly on the damp print image 20′ of the front, which has not yet been fixed. In order for the print image 20′ not to be removed by the impression roller 126, the surface of the impression roller 126 must have non-stick properties with regard to toner particles and also with regard to the carrier liquid on the recording medium 20.

The developer station 110 inks the latent print image 20′ with a predetermined toner. For this purpose, the developer roller 111 introduces toner particles onto the photoconductor. In order to ink the developer roller 111 itself with an all-over layer, liquid developer is firstly fed in a predetermined concentration from a mixing container (not shown, inside the liquid control unit 71) to a supply chamber 112 via a liquid inlet 112′. From this supply chamber 112, the liquid developer is fed in abundance to an antechamber 113 (a type of upwardly open trough). An electrode segment 114 is arranged towards the developer roller 111 and forms a gap between itself and the developer roller 111.

The developer roller 111 rotates through the upwardly open antechamber 113 and carries liquid developer along into the gap. Excess liquid developer passes from the antechamber 113 back to the supply chamber 112.

Owing to the electric field formed between the electrode segment 114 and the developer roller 111 owing to the electrical potentials, the liquid developer in the gap is distributed into two regions, specifically a layer region in the vicinity of the developer roller 111, in which layer region the toner particles are concentrated (concentrated liquid developer), and a second region in the vicinity of the electrode segment 114, which second region is depleted in toner particles (very low-concentration liquid developer).

The layer of liquid developer is then transported on to a metering roller 115. The metering roller 115 squeezes off the upper layer of liquid developer, such that a defined layer thickness of liquid developer of approximately 5 μm thickness remains on the developer roller 111 afterwards. Since the toner particles are located mainly near the surface of the developer roller 111 in the carrier liquid, mainly the carrier liquid on the outside is squeezed off or retained and ultimately recycled to a collecting container 119, but not fed to the supply chamber 112.

As a result, predominantly high-concentration liquid developer is conveyed through the nip between metering roller 115 and developer roller 111. A uniformly thick layer of liquid developer comprising approximately 40 percent by mass toner particles and approximately 60 percent by mass carrier liquid is thus formed downstream of the metering roller 115 (depending on the printing process requirements, the mass ratios may also fluctuate to a greater or lesser extent). This uniform layer of liquid developer is transported into the nip between the developer roller 111 and the photoconductor roller 101. There, the image areas of the latent image are then inked electrophoretically with toner particles, while no toner passes onto the photoconductor in the region of non-image areas. Enough carrier liquid is imperative for electrophoresis. Downstream of the nip the liquid film splits approximately in the middle owing to wetting, such that part of the layer sticks to the surface of the photoconductor roller 101 and the other part (for image areas mainly carrier liquid and for non-image areas toner particles and carrier liquid) remains on the developer roller 111.

In order that the developer roller 111 can be coated with liquid developer again under the same conditions and uniformly, remaining toner particles (these basically represent the negative, non-transferred print image) and liquid developer are removed electrostatically and mechanically by a cleaning roller 117. The cleaning roller 117 itself is cleaned by a blade 118. The cleaned-off liquid developer is fed to the collecting container 119 for recycling, the liquid developer cleaned from the metering roller 115, for example by a blade 116, and the liquid developer cleaned from the photoconductor roller 101 by the blade 104 also being fed to the collecting container 119.

The liquid developer collected in the collecting container 119 is fed to the mixing container via the liquid drain 119′. Fresh liquid developer and pure carrier liquid are also fed to the mixing container as required. There must always be enough liquid in a desired concentration (predetermined ratio of toner particles to carrier liquid) in the mixing container. The concentration is continuously measured in the mixing container and adjusted in accordance with the supply of the amount of cleaned-off liquid developer and the concentration thereof and the amount and concentration of fresh liquid developer and carrier liquid.

For this purpose, maximum-concentration liquid developer, pure carrier liquid, serum (carrier liquid and charge control agents for controlling the charge of the toner particles) and cleaned-off liquid developer can be fed separately to this mixing container from the corresponding reservoirs 72.

The photoconductor can preferably be designed in the form of a roller or as an endless loop. An amorphous silicon as photoconductor material or an organic photoconductor material (also known as OPC) can be used.

Instead of a photoconductor, other image carriers, such as magnetic, ionisable, etc. image carriers, can also be used which do not operate according to the photoelectric principle but rather on which latent images are impressed electrically, magnetically or in another manner according to other principles and then inked and finally transferred onto the recording medium 20.

LED rows or lasers having corresponding scan mechanics can be used as a character generator 109.

The transfer element can also be designed as a roller or as an endless loop. The transfer element can also be omitted. The print image 20′ is then transferred directly from the photoconductor roller 101 onto the recording medium 20.

The term “electrophoresis” is understood to mean the migration of the charged toner particles in the carrier liquid owing to the effect of an electric field. Upon each transfer of toner particles, the corresponding toner particles pass substantially completely onto another element. After contacting of the two elements, the liquid film is split approximately in half owing to the wetting of the elements involved, such that approximately half sticks to the first element and remainder sticks to the other element. The print image 20′ is transferred and then transported on in the next part in order to allow electrophoretic migration of the toner particles again in the next transfer region.

The digital printer 10 can comprise one or more printing units for the front printing and optionally one or more printing units for the back printing. The printing units can be arranged in a line, in an L shape or in a U shape.

Instead of the rewinder 27, finishing apparatuses (not shown) such as cutters, folders, stackers, etc. can also be arranged downstream of the draw unit 26 in order to bring the recording medium 20 into the final form. For example, the recording medium 20 could be processed to the extent that a finished book is produced at the end. The finishing equipment could also be arranged in line or offset therefrom.

As described above as a preferred embodiment, the digital printer 10 can be operated as a reel-to-reel printer. It is also possible to cut the recording medium 20 into sheets at the end and then to stack the sheets or process them in a suitable manner (reel-to-sheet printer). It is also possible to feed a recording medium 20 in sheet form to the digital printer 10 and to stack or process the sheets at the end (sheet-to-sheet printer).

If only the front of the recording medium 20 is printed on, at least one printing unit 11 with at least one color is needed (simplex printing). If also the back is printed on, further at least one printing unit 12 for the back is needed (duplex printing). Depending on the desired print image 20′ on the front and back, the printer configuration includes a corresponding number of printing units for front and back, each printing unit 11, 12 always being set up only for one color or one type of toner.

The maximum number of printing units 11, 12 is only technically limited by the maximum mechanical tensile loading of the recording medium 20 and the free gauge length. Typically, any desired configurations are possible, from a 1/0 configuration (only one printing unit for the front to be printed on) up to a 6/6 configuration, in which six printing units are provided for the front and six for the back of the recording medium 20. The preferred embodiment (configuration) is shown in FIG. 1 (a 4/4 configuration), with which full-color printing is executed for the front and the back using the four basic colors. The sequence of printing units 11, 12 in four-color printing preferably goes from a printing unit 11, 12 which prints light (yellow) to a printing unit 11, 12 which prints dark, that is to say for example the recording medium 20 is printed on from light to dark in the color sequence Y-C-M-K.

The recording medium 20 can be made of paper, cardboard, carton, or other suitable, also pulp-free, preferably pulp-containing materials which can be printed on.

Even when printing with mineral oil-containing inks (dyes/colorants are solved, respectively suspended in carrier of mineral oil), a possible transfer of mineral oil can be reduced or totally prevented by pre-treating the recording medium, for example based on paper and/or carton, with mineral oil-free, low-migration materials, which preferably are approved for application in printing food packaging, e.g. high-molecular, branched fatty acid esters like polyethylene glycol and sorbitan fatty acid ester, since the mineral oil cannot penetrate into the print substrate and residues of mineral oil remaining on the surface of the print substrate can be evaporated. Thus, only mineral oil-free, low-migrations materials or water remain in the printed product apart from dyes after the printing/drying.

Printing inks thus do not inevitably have to be converted to mineral oil-free, low-migrations carrier materials (or water) in the method of the present disclosure, particularly with regard to the fact that the material spectrum is especially limited in the electrophotographic process (no conductive carrier materials). Printing goods (paper, carton, etc.) produced in this way and supplied afterwards, after usage, to a recycling process contain no mineral oil and thus cannot contaminate recycling cartons.

### LIST OF REFERENCE NUMERALS

10 digital printer
11, 11a-11d printing unit (simplex printing apparatus)
12, 12a-12d printing unit (duplex printing apparatus)
20 recording medium
20′ print image (toner)
20″ transport direction of the recording medium
21 reel (input)
22 unwinder
23 pre-treatment apparatus
24 turning device
25 register unit
26 draw unit
27 rewinder
28 reel (output)
30 fixing apparatus
40 air conditioning module
50 power supply
60 controller
70 liquid management
71 liquid control unit
72 reservoir
100 electrophotography station
101 photoconductor roller
102 erasing light
103 cleaning apparatus (photoconductor)
104 blade (photoconductor)
105 collecting container (photoconductor)
105′ arrow
106 charging device (corotron)
106′ wire
106″ screen
107 air supply duct (aeration)
108 exhaust air duct (venting)
109 character generator
110 developer station
111 developer roller
112 supply chamber
112′ liquid inlet
113 antechamber
114 electrode segment
115 metering roller (developer roller)
116 blade (developer roller)
117 cleaning roller (developer roller)
118 blade (cleaning roller for the developer roller)
119 collecting container (liquid developer)
119′ liquid drain
120 transfer station
121 transfer roller
122 cleaning unit (wet chamber)
123 cleaning brush (wet chamber)
123′ cleaning liquid inlet
124 cleaning roller (wet chamber)
124′ cleaning liquid drain
125 conditioning element (retaining plate)
126 impression roller
127 cleaning unit (impression roller)
128 collecting container (impression roller)
128′ liquid drain
129 charging unit (corotron at transfer roller)

1. A method for printing on a recording medium, particularly a packaging, preferably a packaging for food, with liquid developer comprising toner particles and an oil carrier, wherein the recording medium is pre-treated before the printing with at least one mineral oil-free, low-migration pre-treatment material selected from branched fatty acid esters with a molecular weight of at least 500 daltons and/or a viscosity of higher than 5 mm²/s (cSt) at 100° C., like polyethylene glycol ester, polyoxyethylene sorbitan monolaurate, pentaerythritol tetraoctanoate, and/or solutions of branched fatty acid esters with a molecular weight of at least 500 daltons and/or a viscosity of higher than 5 mm²/s (cSt) at 100° C., preferably in liquid form.

2. The method of claim 1, wherein the pre-treatment material is applied on the recording medium uniformly.

3. The method of claim 1, wherein the pre-treatment is carried out in-line inside the printing arrangement.

4. The method of claim 1, wherein the pre-treatment with the pre-treatment material is carried out for a time between 1 msec and 10 sec.

5. The method of claim 4, wherein the pre-treatment with the pre-treatment material is carried out for a time of less than 1 sec.

6. The method of claim 1, wherein the pre-treatment with the pre-treatment material is carried out at a temperature in the range between 10° C. and 120° C.

7. The method of claim 5, wherein the pre-treatment with the pre-treatment material is carried out at a temperature in the range between 20° C. and 40° C.

8. The method of claim 1, wherein solvent residues of the printing ink remaining after the printing on the recording medium are removed.

9. The method of claim 8, wherein the solvent residues of the printing ink remaining after the printing on the recording medium are mineral oils which are removed by a drying process.

10. The method of claim 1, wherein the recording medium comprises paper or carton.

11. The method of claim 1, wherein the recording medium is a packaging or a packaging for food.

12. A printing arrangement for printing on a recording medium with liquid developer comprising toner particles and an oil carrier, the printing arrangement comprising:
at least one printing apparatus for liquid developer comprising toner particles and an oil carrier, which is designed to print on the recording medium on at least one side of the recording medium with a liquid developer comprising toner particles and an oil carrier,
a pre-treatment apparatus arranged in printing direction before the printing apparatus and designed to pre-treat the recording medium before the printing with at least one mineral oil-free, low-migration pre-treatment material.

13. The printing arrangement of claim 12, wherein the pre-treatment apparatus comprises an applicator designed to apply the pre-treatment material uniformly on the recording medium.

14. The printing arrangement of claim 12, wherein the printing arrangement is designed to print on packaging or on food packaging.

15. The printing arrangement of claim 12, wherein a heating device is provided which is arranged in printing direction after the printing apparatus and which is designed to remove solvent residues of the printing ink remaining after the printing on the recording medium.
